(19) United States
(12) Patent Application Publication
(10) Pub. No.: US 2025/0148260 A1
(43) Pub. Date: May 8, 2025

(54) DATA MULTIPLEXING FOR NEURAL NETWORKS

(71) Applicant: The Trustees of Princeton University, Princeton, NJ (US)

(72) Inventors: Karthik NARASIMHAN, Princeton, NJ (US); Vishvak MURAHARI, Princeton, NJ (US); Carlos JIMENEZ, Princeton, NJ (US); Runzhe YANG, Princeton, NJ (US); Ameet DESHPANDE, Princeton, NJ (US); Yushan SU, Princeton, NJ (US); Kai LI, Princeton, NJ (US)

(73) Assignee: The Trustees of Princeton University, Princeton, NJ (US)

(21) Appl. No.: 18/838,096

(22) PCT Filed: Feb. 14, 2023
(86) PCT No.: PCT/US2023/013018

§ 371 Date: Aug. 13, 2024

Related U.S. Application Data
(60) Provisional application No. 63/309,903, filed on Feb. 14, 2022.

(51) Int. Cl. G06N 3/04

(52) U.S. Cl. CPC G06N 3/04

(57) ABSTRACT

Disclosed is a technique for improving the throughput of a neural network, using multiplexing and demultiplexing of information. Specifically, the multiplexing may include receiving a plurality of inputs, generating transformed inputs by performing, via a multiplexing layer, a transformation to each input of the plurality of inputs, and combining the transformed inputs into a single compact representation of the plurality of inputs. The demultiplexing may include receiving an output from a neural network, generating a plurality of values by converting, via a demultiplexing layer, the output back into independent representations, and producing predictions for each input based on the plurality of values. Further improvements may be seen when pretraining of the neural network and/or high-throughput transformers are incorporated.

### CROSS-REFERENCE TO RELATED APPLICATIONS

This application claims priority to U.S. Provisional Patent Application 63/309,903, filed Feb. 14, 2022, the entire contents of which are incorporated by reference herein.

### TECHNICAL FIELD

This application is drawn to improvements in the performance of neural networks, and specifically to techniques for increasing throughput through neural networks.

### BACKGROUND

Deep learning is ubiquitous in today's world, for use with robots and autonomous vehicles, to improvements for voice-powered assistants, no aiding in scientific breakthroughs in a variety of fields. Deep learning approaches typically utilize large models for improving effectiveness. For example, OpenAI's GPT-3 model utilizes over 100 billion parameters in its model. These large models consume a very large amount of compute resources and require large amounts of energy to power those resources. By one estimation, producing enough energy for three months of running one instance of the GPT-3 model would generate more than 14,256 pounds of CO₂ emissions.

Such requirements are a heavy burden as these models are scaled up and democratized. Thus, there is a need for improving the performance of such models.

### BRIEF SUMMARY

Various deficiencies in the prior art are addressed below by the disclosed compositions of matter and techniques.

In one aspect of the present disclosure, a method for improving the throughput of a neural network may be provided, with various versions sometimes including the term “DataMUX”, including “PT-DataMUX”. The method may include a multiplexing phase of receiving a plurality of inputs, and generating transformed inputs by performing, via a multiplexing layer, a transformation (such as a fixed linear transformation, or other transformation) to each input of the plurality of inputs. These transformed inputs are then combined into a single compact representation of the plurality of inputs. In some embodiments, the single compact representation may be transmitted to a base neural network. After the base neural network performs its operations, a demultiplexing phase may occur, wherein output from the neural network is received, and a plurality of distinct output values are generated by converting, via a demultiplexing layer, the output back into independent representations. These distinct output values can then be used to produce predictions for each input.

In some embodiments, the demultiplexing layer may utilize a multihead neural network, such as a multilayer perceptron. In some embodiments, the demultiplexing layer may use a set of input-specific keys or indices, which may include index embedding.

In some embodiments, a training phase may be used. The training phase may include a retrieval warmup step, which may include retrieving correct tokens and order for each position and sequence of the plurality of inputs. In some embodiments, the training phase may include pretraining the neural network after the warmup step, which may use a masked language modeling objective. In some embodiments, the training phase may include finetuning the neural network after pretraining, which may include training on a specific downstream task.

In some embodiments, one or more transformers in the model, such as a transformer between the multiplexing layer and a demultiplexing layer, may be transformed via pruning and/or distillation. In some embodiments, the method may include a prediction step, using a task accuracy model and a throughput model, that predicts parameters for improving throughput while also meeting a given accuracy budget.

In another aspect of the present disclosure, a non-transitory computer-readable storage medium may be provided. The non-transitory computer-readable storage medium may contain instructions that, when executed, cause a processor to perform operations that include some or all of the embodiments of the method as disclosed herein.

In another aspect of the present disclosure, a system may be provided. The system may include a processor operably coupled to a non-transitory computer-readable storage medium. The non-transitory computer-readable storage medium may contain instructions that, when executed, cause the processor to perform operations that include some or all of the embodiments of the method as disclosed herein.

In another aspect of the present disclosure, a neural network apparatus may be provided. The apparatus may include a processor operably coupled to memory. The processor may be configured to generate a neural network with a plurality of layers. The plurality of layers may include (i) a multiplexing layer configured to perform a fixed linear transformation to each received input before combining them into a single compact representation; (ii) one or more layers defining a base neural network, the base neural network configured to receive output from the multiplexing layer; and (iii) a demultiplexing layer configured to convert output of the base neural network back into independent representations. The multiplexing layer may be further configured to perform a retrieval warmup to promote distinguishing order and content of individual sequences in a multiplexed representation. In some embodiments, the one or more layers may include a transformer that has been transformed via pruning and/or distilling.

### BRIEF DESCRIPTION OF FIGURES

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a flowchart of an embodiment of a method.

FIG. 2 is an illustration of an embodiment of the multiplexing/demultiplexing technique.

FIG. 3 is a schematic of a system.

FIG. 4 is an illustration of an embodiment of a retrieval warmup technique.

FIGS. 5A-5E are graphs representing multiplexing task evaluations for the T-MUX example, for sentence classification tasks (MNLI (5A), QNLI (5C), QQP (5D), and SST2 (5E)), and a token-level classification task (NER (5B)).

FIG. 6 is a graph showing the accuracy for an example retrieval warmup task.

FIGS. 7A and 7B are graphs showing efficiency results for multiplexing models for ˜20,000 MNLI instances, and specifically total runtime (7A) and throughput (7B) metrics across different model sizes and different numbers of instances, normalized by base model performance without multiplexing.

FIGS. 8A and 8B are graphs showing multiplexing performance with smaller model capacities for a sentence classification task (MNLI (8A)) and a token-level classification task (NER (8B)).

FIG. 9 is a graph showing MNLI accuracy for different demultiplexing output indices; results are reported for a Transformer model with the Hadamard product multiplexing and Index Embeddings demultiplexing.

FIG. 10 is a graph showing average test accuracy for multiplexing MLP and CNN for N={1, 2, 4, 8, 16} on the MNIST classification task for different multiplexing strategies.

FIG. 11 is a schematic illustration of training for a MUX-BERT model.

FIG. 12 is a schematic illustration of an RSA-inspired demultiplexing module.

FIG. 13 is a schematic illustration of an attention-based multiplexing module.

FIGS. 14A and 14B are graphs showing BERT GLUE performance and throughput (14A) and BERT Token task performance and throughput (14B) for N=1, 2, and 5 with the small (“S”), base (“B”), and large (“L”) configurations, where all multiplexed models lie either on or very close to the Pareto frontier for both GLUE and token-level tasks (shown as black line).

FIG. 15 is a series of graphs showing (Top) Average layer-wise activation values for multiplexed (N=2, 5, 10) and baseline (N=1) BERT models for small, base and large configurations, and (Bottom) Average entropies of the attention distributions at every layer for multiplexed (N=2, 5, 10) and baseline models (N=1).

FIG. 16 is an illustration of PruMUX showing a multiplexer, sparse Transformer, and a demultiplexer, with multiplexing width of 10, where 10 input sequences are mixed into 1 input sequence. The multiplexed Transformer model is pruned to reduce inference time. The training for PruMUX consists of three steps including retrieval warm-up, multiplexed model training, and transformer pruning.

FIGS. 17A-17D are graphs showing throughput improvement(x) of PruMUX, DataMUX, and CoFi pruning (Xia et al., 2022) over the BERT-base model for the MNLI (17A), QNLI (17B), QQP (17C), and SST-2 (17D) tasks. Note the x-axis is the Transformer accuracy, which is inverted to better show throughput improvements of each method for different accuracy loss budgets.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

References listed herein are incorporated by reference in their entirety as if fully set forth herein.

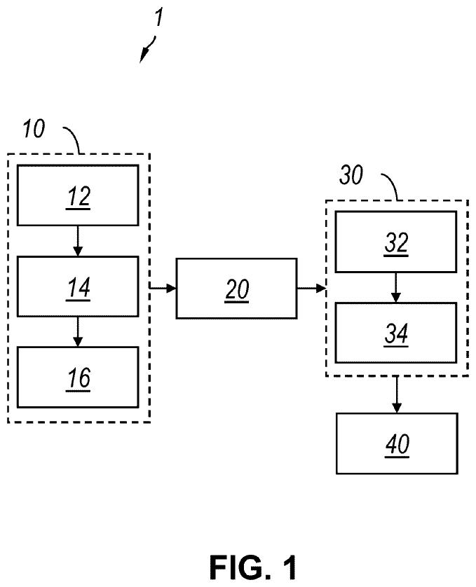

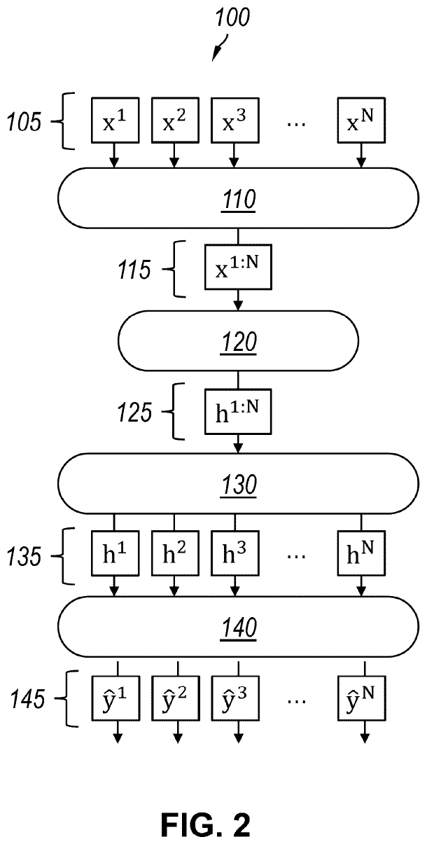

In one aspect of the present disclosure, a method for improving the throughput of a neural network may be understood with reference to FIGS. 1 and 2. Referring to FIG. 1, the method 1 may include a multiplexing phase 10. The multiplexing phase may include receiving 12 a plurality of inputs, and generating 14 transformed inputs by performing, via a multiplexing layer, a transformation to each input of the plurality of inputs. These transformed inputs are then combined 16 into a single compact representation of the plurality of inputs.

Various transformations can be used here. In some embodiments, a fixed linear transformation is used. However, other transformations may also readily be used, including a non-linear function that is either fixed or learnable.

This can be seen in FIG. 2, where the technique 100 is shown as having a plurality of inputs 105 (e.g., x¹, x², x³, . . . , x^{N}) be received by the multiplexer 110. The output 115 from the multiplexer is a single compact representation (e.g., x^{1:N}).

In some embodiments, the single compact representation may then be transmitted 20 to a base neural network 120.

The architecture of the base neural network may include any network architecture as understood by those of skill in the art. This may include the use of, e.g., Transformers, Multi-layer Perceptrons (MLPs), or Convolutional Neural Networks (CNNs).

The multiplexer preserves the order of the combined instances and therefore allows mixed instances to be used during inference. The primary goal is to process a set of input instances simultaneously over a shared neural network (multiplexing) with minimal overhead during inference. To this end, the multiplexer module may be designed to combine the multiple input instances into a superposed representation.

The multiplexer module, denoted Φ, combines a tuple of inputs, e.g., images or sentences from a batch, (x¹, . . . , x^{N}), for xⁱ∈ [symbol] ^{d}, into a more compact representation x^{1:N}∈ [symbol] ^{d} in an order-dependent way, which enables effective demultiplexing after processing, as well as distinguishing intra-sequence interactions in the case of sequenced inputs (e.g., token sequences). Towards this end, for each input xⁱ with index i∈[1, N] of the input tuple, the multiplexer module performs a transformation ϕⁱ( [symbol] ^{d}→ [symbol] ^{d}), on the instance before finally averaging all inputs into a single multiplexed representation as:

$${x}^{1 : N} = Φ ( {x}^{1} , … , {x}^{N} ) = \frac{1}{N} {\sum }_{i = 1}^{N} {ϕ}^{i} ( {x}^{i} ) . \qquad ( 1 )$$

For sequenced inputs (e.g., token sequences), N sequences are combined by multiplexing token-wise. That is, for inputs of the form xⁱ={wⱼⁱ}_{j∈[1,L]}, where wⱼⁱ∈ [symbol] ^{d} is a token's input vector representation, this operation uses the same transformation ϕⁱ for each token in the sequence before averaging over each position across indices, such that x^{1:N}={wⱼⁱ}_{j∈[1,L]}, where wⱼ^{1:N}∈ [symbol] ^{d} is a multiplexed representation of N tokens at position j, i.e., x^{1:N}={Φ(wⱼⁱ, . . . , wⱼ^{N})}_{j∈[1,L]}.

For ϕⁱ, various options can be used. For example, one can experiment with using either (1) a linear projection with a random fixed orthogonal matrix (denoted “Ortho”) or (2) the Hadamard product with a fixed Gaussian random vector (denoted “Hadamard”, equivalent to a linear map using a diagonal matrix here). These transformations map instances at different indices into distinguishable regions and consequently reduce interference between their representations. Finally, this multiplexed representation, x^{1:N}, is used as input to the neural network backbone (or “base neural network”), which is architecturally unchanged.

After the base neural network performs its operations, a demultiplexing phase 30 may occur. There, output 125 from the base neural network 120 may be received 32, and a plurality of distinct output values 135 are generated 34 by converting, e.g., via a demultiplexing layer of a demultiplexer 130, the output back into independent representations.

In some embodiments, the demultiplexing layer may utilize a multi-head neural network. The multi-head neural network may be, e.g., a multilayer perceptron with non-linear activations or a Transformer.

In some embodiments, the demultiplexing layer may utilize a set of input-specific keys or indices, such as index embedding.

The output of the neural network backbone will generally be a multiplexed hidden representation h^{1:N} of the input x^{1:N}. One can explicitly disentangle h^{1:N} into N individual hidden representations, h¹, . . . , h^{N}, respectively. One first obtains each hⁱ with a demultiplexing function [symbol] ⁱ, i.e.,

$${h}^{i} = {ϑ}^{i} ( {h}^{1 : N} ) , ∀ i ∈ [ 1 , … , N ] . \qquad ( 2 )$$

For sequenced input, demultiplexing is done position-wise, i.e., hⱼⁱ= [symbol] ⁱ(hⱼ^{1:N}) for each position j.

In various embodiments, the demultiplexing function [symbol] ⁱ may be modified.

In some embodiments, the demultiplexing function uses MLP demuxing. Here, N MLPs are employed to generate each indices' hidden representation as to generate each indices' hidden representation as hⁱ=MLPⁱ(h^{1:N}). This approach may be used for, e.g., both natural language processing (NLP) and vision tasks. Although this method is conceptually simple, it adds learnable parameters proportional to N.

In some embodiments, the demultiplexing function utilizes index embeddings. Here, index embeddings pⁱ are generated, which are then concatenated to h^{1:N}, and transformed by a shared multi-layer network to generate each individual hidden representation, i.e., hⱼⁱ=MLP^{shared}(hⱼ^{1:N}, pⁱ). To generate the index embeddings pⁱ, one can add a sequence of N special tokens, called the prefix, to the beginning of each sequence of the input tuple. For multiplexing with N sequences, one can add N corresponding prefixes, denoted prefixⁱ for i∈[1, N]. Each prefixⁱ consists of an index token ∈ⁱ in its i-th position while the remaining tokens are a special pad token ∈^{pad}. The prefix sequences then take on the following pattern:

$${prefix}^{1} = [ {ϵ}^{1} , {ϵ}^{pad} , … , {ϵ}^{pad} ]$$

$${prefix}^{2} = [ {ϵ}^{pad} , {ϵ}^{2} , {ϵ}^{pad} , … , {ϵ}^{pad} ]$$

$$…$$

$${prefix}^{N} = [ {ϵ}^{pad} , … , {ϵ}^{pad} , {ϵ}^{N} ]$$

One then prepends each sequence xⁱ of the input sequence with the corresponding prefixⁱ. The tuple of prepended sequences is then passed to the multiplexing module. When finally generating individual hidden representations, one can use the corresponding hidden representation of each index token εⁱ as the index embedding pⁱ. One can use the Index Embeddings demultiplexing strategy on, e.g., language tasks for the Transformer architecture. For example, the prefix tokens may implicitly enable the Transformer to do instance-specific computations when processing the multiplexed representation and further enable demultiplexing for large N.

Finally, these distinct output values/independent representations (i.e., values 135) from the demultiplexing phase can then be used to produce 40 predictions 145 for each input. Predictions can be made using a shared task head 140 on each inputs' respective individual hidden representation to prevent a substantial increase in the number of parameters and improve training efficiency.

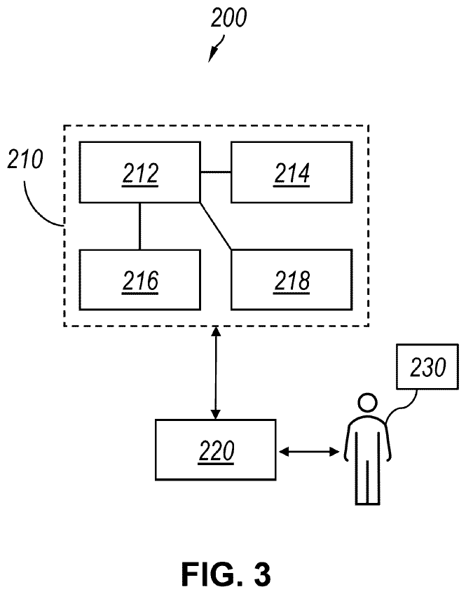

These methods may be implemented in a variety of ways. In some embodiments, a system may be provided. Referring to FIG. 3, a system 200 may include an apparatus 210, which may include one or more processors 212 operably coupled to a memory 214, a non-transitory computer-readable storage medium 216, and an I/O connection 218, which may include, e.g. a wired or wireless connection to a network. In some embodiments, a remote device 220 may be configured to communication with the apparatus. This may include, e.g., sending inputs or receiving outputs from the method disclosed herein. In some embodiments, the remote device 220 may be configured to send or receive information from a user, which may be communicated to the apparatus 210. For example, in some embodiments, the remote device 220 is configured to provide a user interface for receiving input from a user. That input may then be processed and sent to the apparatus for further processing. The non-transitory computer-readable storage medium may contain instructions that, when executed, cause a processor to perform operations that include some or all of the embodiments of the method as disclosed herein.

Thus, a neural network apparatus may be provided, that may include a processor operably coupled to memory. The processor may be configured to generate a neural network with a plurality of layers. The plurality of layers may include (i) a multiplexing layer configured to perform a fixed linear transformation to each received input before combining them into a single compact representation; (ii) one or more layers defining a base neural network, the base neural network configured to receive output from the multiplexing layer; and (iii) a demultiplexing layer configured to convert output of the base neural network back into independent representations.

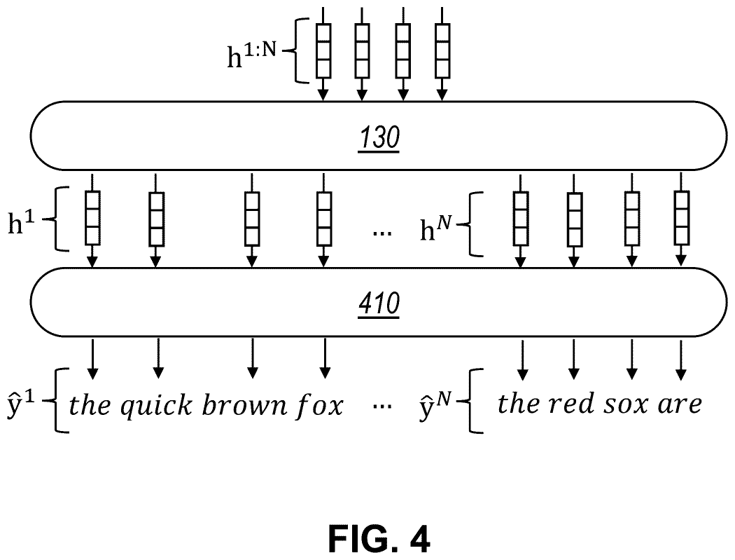

In some embodiments of the disclosed method, a retrieval warmup step may be utilized. For example, when using transformer models, it has been found that naively adding the multiplexing and demultiplexing layers to the model may sometimes fail to converge. This is likely because the gradients for individual instances from the task loss get mixed up in the backward pass. To overcome this, a Retrieval warm-up step is proposed, e.g., for use with sequenced inputs. This is a self-supervised pre-training task to promote the ability of the disclosed models at distinguishing the order and the content of individual sequences in a multiplexed representation. This task consists of retrieving the correct tokens and order for each position and sequence of the input tuple. See FIG. 4.

In FIG. 4, given the Transformer's combined output representation h^{1:N} generated from the input (x¹, x², . . . , x^{N}), the goal of the retrieval task is to retrieve the original tokens from (x¹, x², . . . , x^{N}). Since h^{1:N} is order-dependent, retrieval requires distinguishing not just which tokens were originally input to a position j∈[1, L], but also which sentence i∈[1, N] each belonged to.

In principle, one could add this loss for every sentence in each position. However, due to memory constraints, a preferred approach is to instead retrieve a token from a random sentence for each token position, yielding the following objective:

$${ℒ}_{Retrieval} ( {x}^{1 : N} ) = {\sum }_{j} - log P ( {w}_{j}^{I} \vert {h}_{j}^{I} ) , \qquad ( 3 )$$

where hⱼ^{I} is a demultiplexed hidden representation of the j-th token in a randomly selected sentence with the index I˜ [symbol] [1,N], generated using the methods described above relating to index embedding.

### Examples

### Multiplexing for Transformers (T-MUX)

The capabilities and limits of data multiplexing specifically for the Transformer architecture were evaluated on a range of text classification tasks. DataMUX was applied on a 12-layer Transformer based model with a hidden dimension size of 768 and 12 self-attention heads built on the Huggingface framework, and refer to the resulting model as T-MUX. The T-MUX models are compared to 2 baselines: (B1) a 12-layer 768 hidden dimension vanilla Transformer, and (B2) a 12-layer 768 hidden dimension Transformer pretrained using the retrieval task described herein. Though there is no multiplexing done for B2 (meaning this operation could be solved by simply copying input tokens to the output layer) it is found that this produces differences in performance and for completeness, this baseline is shown. After performing an empirical study to determine smaller transformer models that performed best, DataMUX was also applied to two smaller transformer models: (i) a 12 layer with hidden size of 384 (12L/384H), and a 4 layer with hidden size of 768 (4L/768H), which were compared with similar baselines.

The models and baselines were evaluated on two types of text classification tasks:
1. Token-level classification: This evaluates models' ability to perform token-level tasks on multiplexed inputs. This poses a particular challenge for data-multiplexing models since they must maintain a high level of individual token disentanglement while also producing representations capable of solving the task. Token-level classification was evaluated on the CoNLL-2003 Named Entity Recognition (NER) task.
2. Sentence-level classification: models were evaluated on a subset of the sentence-level classification tasks found in the General Language Understanding Evaluation (GLUE) benchmark: the sentiment classification task SST-2, the sentence similarity task QQP, and the natural language inference tasks MNLI and QNLI. By evaluating on a variety of sentence-level tasks, one can gain a better sense of the capabilities of data multiplexing neural networks on tasks that require aggregating contextual information. Similar to previous works, a [CLS] token was prepended to all sequences and a task head was on top of the demultiplexed [CLS] token representation.

The T-MUX models were all pre-trained using the retrieval warm-up on the Wikitext-103 dataset (Merity et al., 2017) as described previously. In addition, the example also continued to use the retrieval task as an auxiliary objective during task training. The total loss is a combination of the task loss and retrieval loss, i.e.,

$$ℒ = ( 1 - α ) {ℒ}_{T a s k} + {αℒ}_{Retrieval} , \qquad ( 4 )$$

where the coefficient α=0.1 in these experiments.

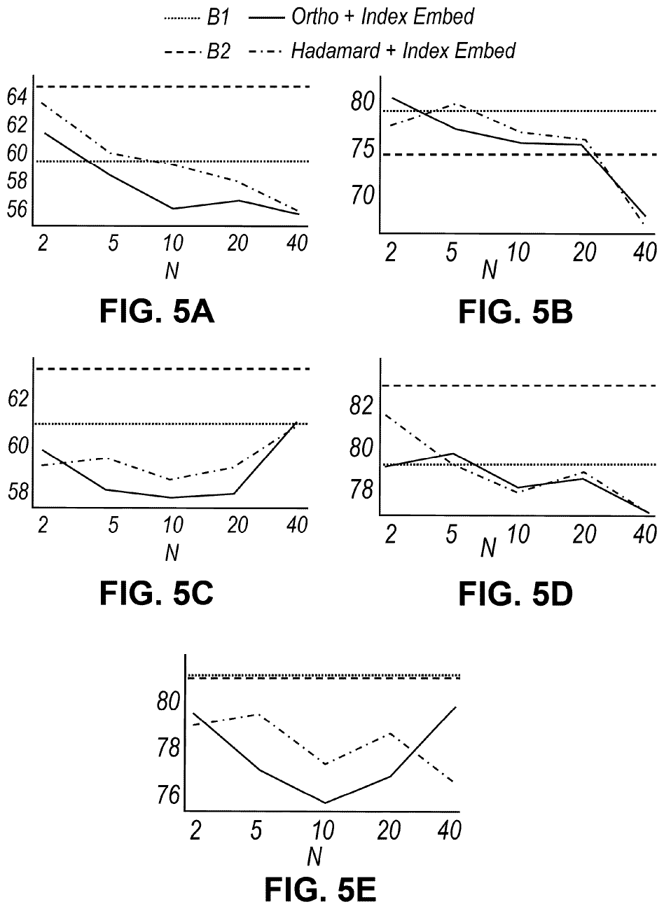

In these examples, it was found that multiplexing leads to minimal drop in performance even for large N. FIGS. 5A-5E shows performance (accuracy) across four sentence classification tasks—MNLI (5A), QNLI (5C), QQP (5D), SST2 (5E) and a token-level classification task (NER, 5B).

It is observed that it is possible to multiplex up to 40 instances and maintain reasonable performance. For easier tasks like QQP, SST2 and QNLI, it is observed that the drop in performance with increasing N is insignificant while for more difficult tasks like MNLI and NER, there is a trade-off between performance and N, with performance dropping 10%-15% for 40 instances. Since unstable optimization were encountered when using MLP Demuxing, only results using Index Embeddings demultiplexing were provided. It was found that the multiplexing strategy does not impact performance across different tasks, even slightly increasing for small values of N (e.g., 2, 5). This increase may be attributable to implicit regularization.

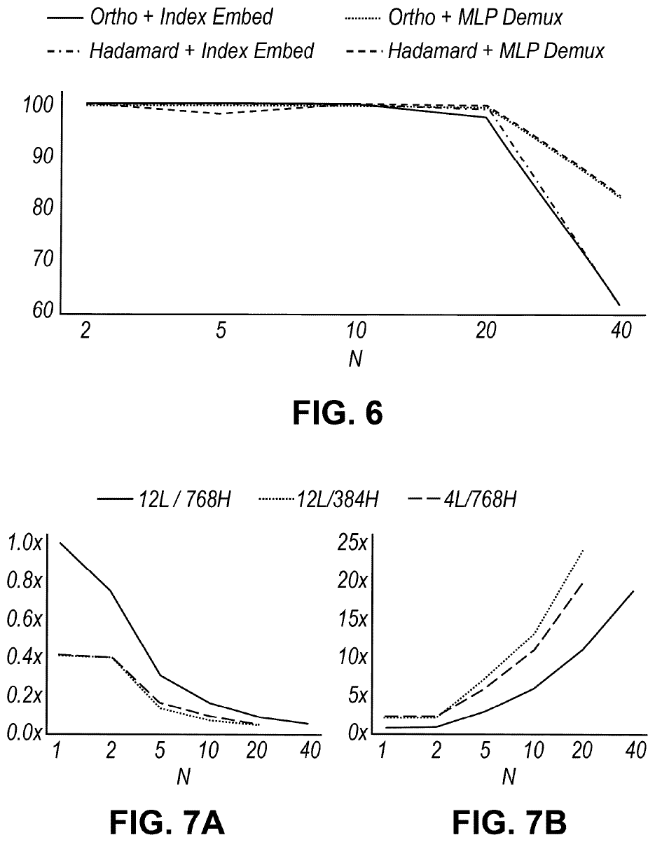

In these examples, it was found that there was perfect multiplexing on the retrieval warm-up task for large N. FIG. 6 shows the test accuracy on the retrieval warm-up task disclosed herein. It is first noted that across different multiplexing and demultiplexing strategies, models have a retrieval accuracy of nearly 100% for up to 20 instances, demonstrating the surprising ability of T-MUX to multiplex perfectly for large N. Note that this task does not require any aggregation of context across the sequence and thereby is much easier than sentence classification or token-level classification tasks. Therefore, performance on this warm-up task indicates a soft upper bound on the number of instances one can multiplex for sentence and token-level classification tasks given a particular multiplexing and demultiplexing method.

In these examples, it was found that throughput can be increased multi-fold using the disclosed techniques. Throughput of a multiplexed model (Hadamard+Index Embed) was measured across different number of instances by calculating inference speed for processing ˜20,000 samples on the MNLI dataset on a single Nvidia RTX 2080 machine. Four different batch sizes were used for all the configurations and the maximum throughput was taken.

FIGS. 7A (runtime) and 7B (throughput) shows that multiplexing can increase throughput many folds (18× for 40 instances, 11× for 20 instances). T-MUX enables superior throughput as batch size can be effectively increased by a factor of N. One would expect the speedup to scale linearly with N, however in this example, the large N corresponds to more prefix tokens which increases the sequence length. Therefore, in this example, having 40 instances leads to almost a 20× speedup as opposed to the expected 40×.

In these examples, attention heads seems unrelated to multiplexing. To understand the role of the number of attention heads in multiplexing, a variant of T-MUX with 2 self-attention heads per layer was trained, and specifically, T-MUX with the (Hadamard+Index Embed.) configuration. It was found that reducing self-attention heads has minimal effect on performance on the retrieval warm-up task and achieves a retrieval accuracy of ˜100% up to N=20. It was found that on token and sentence-level classification tasks, T-MUX with 2 self-attention heads performs comparably to T-MUX with 12 self-attention heads.

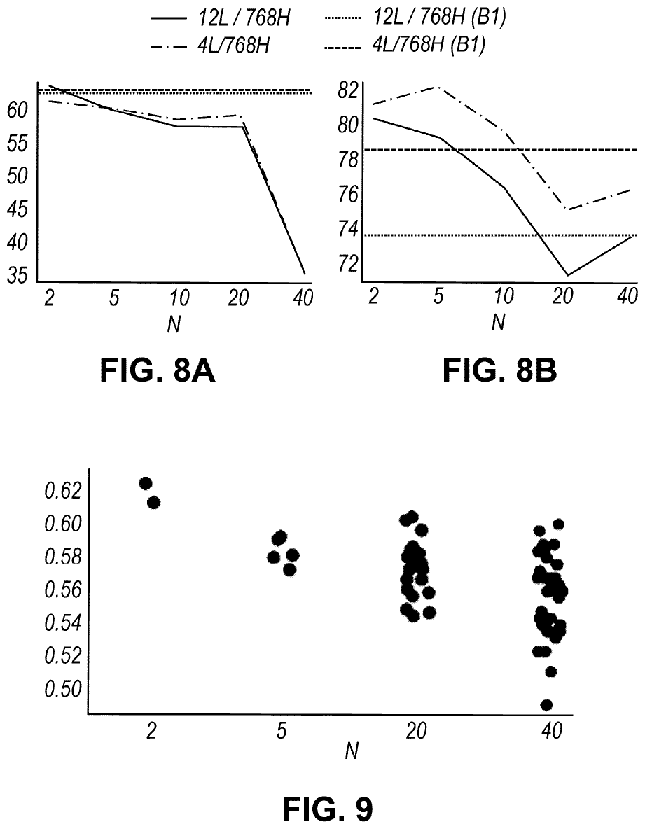

The disclosed techniques also provide throughput boosts with smaller Transformers. Two smaller Transformers were chosen to multiplex: a 12 layer with hidden size of 384 (12L/384H), and a 4 layer with hidden size of 768 (4L/768H). FIGS. 8A and 8B shows that these smaller T-MUX models can also multiplex up to 20 instances with competitive performance. FIG. 6 illustrates the speedup from the smaller models. As the smaller models can only multiplex up to 20 instances with reasonable performance, it can be seen that multiplexing with 20 instances provides an even higher throughput of 25×, compared to only 18× for the full-sized T-MUX with 40 instances.

With these techniques, performance varies more across different indices as N increases. The prediction of an instance is conditioned on the index of the instance. FIG. 9 illustrates performance on MNLI for different indices across different choices of N for the (Hadamard+Index Embed.) configuration. It is observed that performance varies more across different indices for large N (e.g., for N=40, performance varies across ˜10 percentage points).

Further, one can construct self-attention based neural networks which always process multiplexed token embeddings in N independent subspaces. One possible construction relies on particular structures of singular spaces of linear transformations across layers.

The multi-head attention projects the queries, keys, and values h times with different, learned linear projections to d_{K}, d_{K}, and d_{V} dimensions respectively. I.e., given a sequence of d-dimensional multiplexed token embeddings {wₜ^{1:N}}_{t∈[1,L]}, each head is

$${head}_{i} ( t ) := {\sum }_{{t}^{′} = 1}^{L} [ \frac{exp ( \frac{{( {W}_{i}^{K} {w}_{{t}^{′}}^{1 : N} )}^{⊤} {W}_{i}^{Q} {w}_{t}^{1 : N}}{\sqrt{{d}_{K}}} )}{{\sum }_{{t}^{″}} exp ( \frac{{( {W}_{i}^{K} {w}_{{t}^{″}}^{1 : N} )}^{⊤} {W}_{i}^{Q} {u}_{t}}{\sqrt{{d}_{K}}} )} {W}_{i}^{V} {w}_{{t}^{′}}^{1 : N} ] . \qquad ( 5 )$$

Since

$${w}_{t}^{1 : N} = \frac{1}{N} {\sum }_{k = 1}^{N} {ϕ}^{k} ( {w}_{t}^{k} ) ,$$

and it is assumed each function ϕ^{k} projects each embedding into a subspace which is least linearly-dependent with the others. I.e., defining

$${u}_{t}^{( k )} := \frac{1}{N} {ϕ}^{k} {w}_{t}^{k} ,$$

it is assumed [symbol] uₜ^{(k)},uₜ^{(k′)} [symbol] ≈0 for all pairs of indices k≠k and all positions t. To preserve such independent subspace structure after projection, one will first need

$$〈 {W}_{i}^{V} {u}_{t}^{( k )} , {W}_{i}^{V} {u}_{t}^{( {k}^{′} )} 〉 = {u}_{t}^{{( k )}^{⊤}} ( {W}_{i}^{{V}^{⊤}} {W}_{i}^{V} ) {u}_{t}^{( {k}^{′} )} \approx 0. \qquad ( 6 )$$

This is achievable if the eigenvectors of Wᵢ^{V}^{^{T}}Wᵢ^{V} can be grouped into N non-overlapping subsets {r₁⁽¹⁾, . . . , rₘ⁽¹⁾}, . . . , {r₁^{(N)}, . . . , rₘ^{(N)}}, where r are orthonormal vectors (since the Gramian is real symmetric), and span the same input subspaces, denoted as [symbol] ¹, . . . , [symbol] ^{N}. In this case, the vector after transformed by Wᵢ^{V} can be expressed as a sum of N vectors v_{i,t}⁽¹⁾, . . . , v_{i,t}^{(N)} in dual subspaces [symbol] _{V}¹, . . . , [symbol] _{V}^{N} which are independent of each other. The linear maps from [symbol] ^{k} to [symbol] _{V}^{k} still allows rich operation on each component of a multiplex input without interference by other components.

In addition to decompress-able value vectors, one can set the query and key matrices, Wᵢ^{Q} and Wᵢ^{K}, to have some subsets of right and left singular vectors such that span [symbol] ¹, . . . , [symbol] ^{N} and [symbol] _{V}¹, . . . , [symbol] _{V}^{N}. Then one can show that the inner product between the query and keys of the i-th head can be rewritten as

$${( {W}_{i}^{K} {W}_{{t}^{′}}^{1 : N} )}^{⊤} {W}_{i}^{Q} {w}_{t}^{1 : N} = {\sum }_{k = 1}^{N} {τ}_{i , t , {t}^{′}}^{( k )} \qquad ( 7 )$$

where τ_{i,t,t}^{(k)}, is a scalar only depending on the k-th input sequence. Thus, the self-attention operation at each position can be seen as retrieving values based on the average of query-key similarity scores of N sequences.

$${head}_{i} ( t ) := {\sum }_{{t}^{′}} [ \frac{exp ( {\sum }_{k} {τ}_{i , t , {t}^{′}}^{( k )} / \sqrt{{d}_{K}} )}{{\sum }_{{t}^{″}} exp ( {\sum }_{k} {τ}_{i , t {,}^{″}}^{( k )} / \sqrt{{d}_{K}} )} {\sum }_{k} {v}_{i , t}^{( k )} ] \qquad ( 8 )$$

The average retrieval by soft-max could be a desired property as implicit regularization. However, if one wants perfect non-interference in retrieval, the network always has an option to specialize each head to only focus on one input sequence, by setting τ_{i,t,t}^{(k′)}=0 for all k′≠k, which is easily achievable by controlling singular values of Wᵢ^{Q} or Wᵢ^{K}.

### Multiplexing for MLPs and CNNs

Certain cases of data multiplexing have been explored for convolutional architectures on image classification as techniques for robustness and data augmentation. Those works implicitly employed the frontend layers of a convolutional net as multiplexing layers and suggest that a convolutional neural network can learn at most 3-4 independent subnet-works concurrently. However, for Transformers, the disclosed technique has demonstrated multiplexing up to 40 instances without a severe performance drop. To better understand data multiplexing on such alternative architectures, one can apply DataMUX to MLPs and CNNs for the MNIST image classification task.

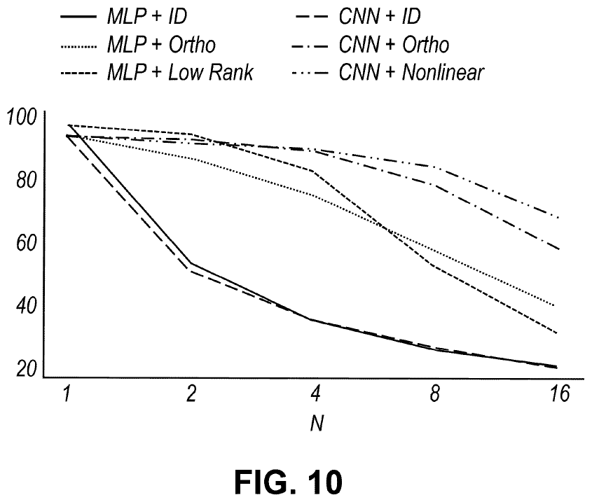

FIG. 10 illustrates performance of DataMUX for MLPs with various multiplexing strategies, though all methods use the MLP Demux. demultiplexing strategy. As a baseline, multiplexing using the identity transformation is shown before combining instances (MLP+ID). Since this transformation does not preserve the order of the multiplexed instances, accuracy expectedly decreases on the order of 1/N. Random orthogonal matrices (MLP+Ortho) is then used for multiplexing and it was found that MLPs can multiplex up to 8 instances with an accuracy of ˜78%, compared to ˜95% for the baseline without multiplexing. However, random orthogonal projections cannot separate inputs perfectly. Suppose two linear separation functions G and H are expected to separate all inputs from a manifold [symbol] , one would expect v^{T}G^{T}Hu=0 for all v and u∈ [symbol] . If the dimensionality of the manifold [symbol] is not too low, then we will need G^{T}H=0, which implies rank(G)+rank(H)≤d, but the ‘Ortho’ transformations are full rank. A low-rank transformation could help enable zero interference among inputs. This example therefore generated a set of N low-rank independent transformations for multiplexing (MLP+LowRank) and it was observed that this improves performance for larger N.

### Multiplexing for CNNs

Different multiplexing strategies for CNN architectures were compared, with performance results shown in FIG. 10. As in the MLP architecture, all methods shown use the MLP Demux strategy. Similar to MLPs, the identity separation function leads to roughly N-fold performance drop because of the unidentifiably of input order. The “Ortho” transformation also performs much worse than the MLP variant (only ˜56% for N=8). This is likely because this transformation destroys the spatial locality that CNNs may rely on. The example therefore also tries N two-layer convolutional networks with a tan h activation as our multiplexing transformations ϕⁱ (CNN+Nonlinear). Identical to previous multiplexing strategies, the dimensionality of the multiplexed representation is equal to the dimensionality of a single input. It is noted that for N≤4, performance is above 80%, which is significantly better than CNN+Ortho. However performance drops rapidly for N>4.

Additionally, it is noted that a training phase, which may include, e.g., pretraining techniques, can be used effectively with the above to improve overall performance of the models. The training may include, e.g., a warmup step, a pretraining step, a finetuning step, or a combination thereof. In a preferred embodiment, the training includes a warmup step, a pretraining step, and a finetuning step.

In some embodiments, the training phase may include a warmup step comprising retrieving correct tokens and order for each position and sequence of the plurality of inputs. This process may include multiplexing multiple sequences of tokens, feeding the multiplexed sequence through the base neural network, and demultiplexing to predict the original token in each position of each sequence.

In some embodiments, the training phase may include pretraining the neural network after the warmup step. The pretraining may include using a masked language modeling objective. This may include masking certain tokens in the inputs (i.e. replacing them with a specific [MASK] token) and using the model to predict the masked tokens from the context of other unmasked tokens.

In some embodiments, the training phase may include finetuning the neural network after pretraining. The finetuning may include training on a specific downstream task. This may include training the model to perform a specific task (like sentiment analysis) using human annotated data.

### Example 2

Here, techniques were explored to obtain pretrained language models with data multiplexing, with a focus on masked LMs like BERT and ELECTRA. The disclosed models can process multiple inputs (2-10) in parallel with a forward pass over a single instance and can be fine-tuned for any downstream task as compared to those base models. Importantly, MUX-PLMs do not require fine-tuning or apriori access to task-specific data, in contrast to other methods like pruning.

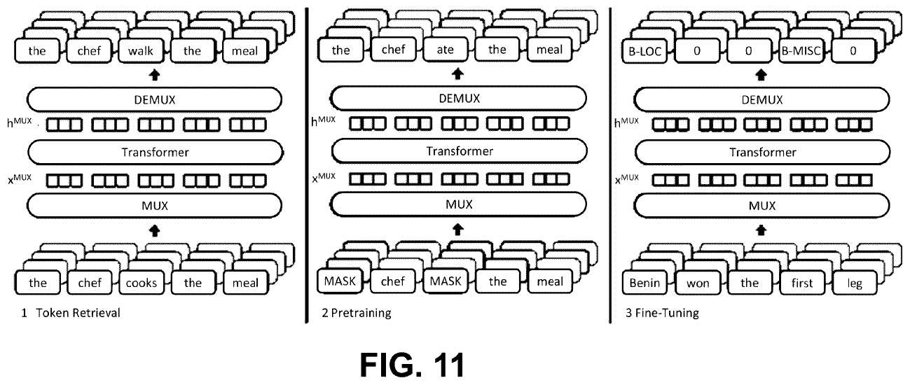

The disclosed approach involves a three-stage training procedure including 1) a retrieval warmup, 2) multiplexed pretraining and 3) finetuning on downstream tasks. See FIG. 11.

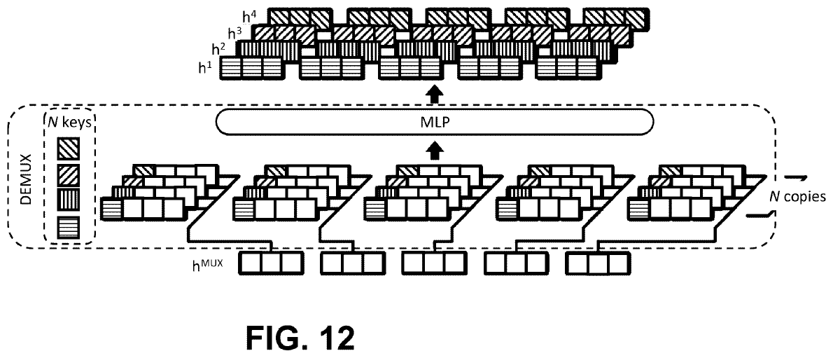

In this example, a demultiplexing module (see FIG. 12) was introduced that retains a constant size with more inputs, as opposed to a defacto prefix token approach.

The module is initialized with N key vectors which are used to demultiplex the transformed multiplexed representations (h^{MUX}). The keys are concatenated with h^{MUX} and are processed with an MLP to generate the demultiplexed output representations (h₁, . . . , h₄).

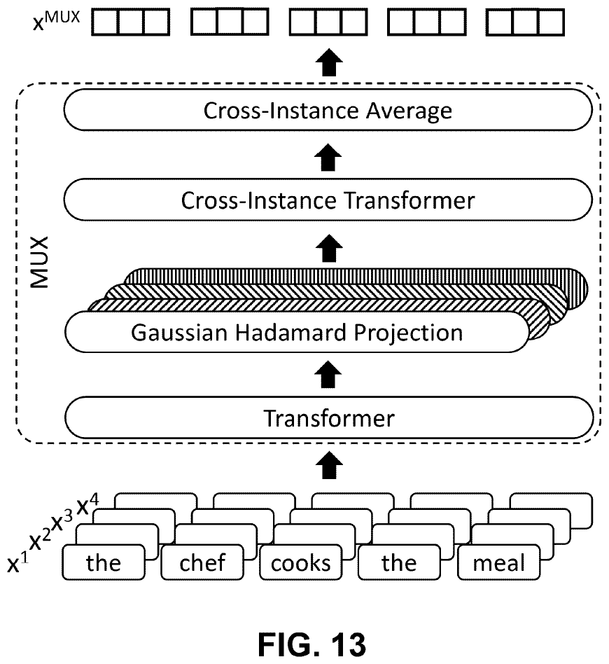

This helps improve the inference throughput, greatly improves pre-training and consequentially leads to more performant fine-tuned models. Finally, an attention-based multiplexing approach (see FIG. 13) was used that aggregates context from the set of multiplexed instances by learning additional parameters and significantly improves performance on token-level tasks.

In the attention-based multiplexing approach, the multiplexing module first generates contextual representations for x₁, . . . , x₄ with a transformer layer, then a hadamard product is done between the contextual representations and the corresponding multivariate gaussian to generate instance-conditioned representations. Then, the multiplexed representations are generated with another Transformer layer, by attending across the instances for all the positions in the sequence.

The example models (MUX-BERT and MUX-ELECTRA) were evaluated on several downstream sequence classification tasks from the GLUE benchmark as well as token classification tasks like named entity recognition and part-of-speech tagging. The exemplary models achieve close to the state-of-the-art scores that standard BERT and ELECTRA models obtain while attaining a multi-fold throughput increase. For instance, MUX-BERT can get a 4.9× speedup over BERT while only being 4 points and 2 points worse in scores for GLUE and token classification tasks, respectively. The various versions of the multiplexed models were compared along the accuracy-efficiency Pareto front to demonstrate the flexibility of the pre-trained MUX models, depending on the downstream application. Finally, several ablation studies were performed, and the internal representations of MUX-BERT were analyzed to provide more insight into data multiplexing in language models.

The multiplexer model (MUX) combines an ordered set of multiple inputs—X^{1:N}=(x¹, . . . , x^{N}) into a single superimposed representation (x^{MUX}). If xⁱ∈ [symbol] ^{d}, the multiplexer is a transformation (MUX: [symbol] ^{N×d}→ [symbol] ^{d}) such that x^{MUX}=MUX(X^{1:N}). To ensure MUX is an order-preserving transformation, DataMUX samples a vector (vⁱ∈ [symbol] ^{d}) from a standard multivariate gaussian and applies the hadamard product (element-wise multiplication) with the corresponding input representation (xⁱ) before summing up vectors for all positions.

$${x}^{MUX} = M U X ( {X}^{1 : N} ) = \frac{1}{N} {\sum }_{i = 1}^{N} {x}^{i} ⊙ {v}^{i} \qquad ( 2 - 1 )$$

$${v}^{i} ∈ {ℝ}^{d} ∼ ( 0 , I )$$

The model processes the multiplexed representation and emits a multiplexed hidden state—h^{MUX}=M(x^{MUX}). To multiplex Transformers' sequenced inputs (xⁱ=(x₁ⁱ, . . . , x_{L}ⁱ)) of length L, apply the same vⁱ to all L positions of instance i.

$${x}^{MUX} = MUX ( {X}^{1 : N} ) = ( \frac{1}{N} {\sum }_{i = 1}^{N} {x}_{1}^{i} ⊙ {v}^{i} , … , \frac{1}{N} {\sum }_{i = 1}^{N} {x}_{L}^{i} ⊙ {v}^{i} ) \qquad ( 2 - 2 )$$

For the demultiplexer, a prediction needs to be made for each instance in X^{1:N}. In some embodiments, this can be done by separating the superimposed output (h^{MUX}) into N output representations corresponding to the input (h¹, . . . , h^{N}).

$${h}^{i} = DeMUX ( {h}^{MUX} , {p}^{i} ) \qquad ( 2 - 3 )$$

$${h}_{j}^{i} = DeMUX ( {h}_{j}^{MUX} , {p}^{i} )$$

The vector pⁱ∈ [symbol] ^{d} is dynamically generated for each instance (i) with the help of a prefix that is added to the input, and re-used for all positions in the instance. They add a prefixᵢ to xⁱ, represented by the following pattern, where ∈ⁱ is a token that is unused by the model, and pⁱ is set to be the output corresponding to token i in the prefix.

$${prefix}^{1} = [ {ϵ}^{1} , {ϵ}^{pad} , … , {ϵ}^{pad} ]$$

$${prefix}^{2} = [ {ϵ}^{pad} , {ϵ}^{2} , {ϵ}^{pad} , … , {ϵ}^{pad} ]$$

$$…$$

$${prefix}^{N} = [ {ϵ}^{pad} , … , {ϵ}^{pad} , {ϵ}^{N} ]$$

Modern NLP systems overwhelmingly rely on pre-trained models. Therefore, an exemplary PT-DataMUX which applies DataMUX during pre-training (both for BERT and ELECTRA) to yield MUX-BERT and MUX-ELECTRA models. In this example, the models were trained in three stages (see FIG. 11), where the model was first primed with the token retrieval task described herein, before optimizing the model on the pre-training objective. It is shown that this leads to large gains in performance when compared to DataMUX (i.e., without the additional steps disclosed in this example), and significant throughput improvement over standard pre-trained LMs while matching their downstream task accuracies. Furthermore, PT-DataMUX is not task-specific, and the same model can be fine-tuned for any downstream task.

Contextual multiplexer. The multiplexer used in DataMUX multiplexes tokens independent of 1) tokens in the same position in other instances and 2) other tokens in the instance, which could lead to suboptimal representations. Therefore, in PT-DataMUX, a contextual multiplexing scheme is explored that cleverly aggregates context both from tokens in the same instance and tokens in the same position of other instances (see FIG. 13). A single transformer layer TRANS_{ctx} is used to get contextual representations h_{ctx}ⁱ=TRANS_{ctx}(x₁ⁱ, . . . , x_{L}ⁱ) of length L. Similar to DataMUX, here PT-DataMUX applies a hadamard product with a multivariate gaussian vⁱ to all L positions.

$${g}_{ctx}^{i} = {h}_{ctx}^{i} ⊙ {v}^{i} \qquad ( 2 - 4 )$$

PT-DataMUX then generates multiplexed representations, x^{MUX}, by applying another transformer layer TRANSᵢₙₛₜ across encoded representations from N instances at each position from 1 to L. This can be achieved by, e.g., transposing g_{ctx} and applying TRANSᵢₙₛₜ.

$${x}^{MUX} = {TRANS}_{inst} ( {g}_{ctx}^{T} ) \qquad ( 2 - 5 )$$

RSA Demultiplexer. The demultiplexer in DataMUX requires a prefix whose length scales linearly with the number of instances (N), thus reducing the effective context length during pre-training, which impacts performance. Furthermore, it decreases throughput during inference for large N because the model needs to process an extra prefix of length N for each of the N instances.

To address these issues, PT-DataMUX draws inspiration from the RSA cryptosystem to randomly initialize and learn N (private) key vectors (k₁, . . . , k_{N}, kᵢ∈ [symbol] ^{d}) which are keys that can be used to demultiplex the output representation (see FIG. 2).

$${h}^{i} = DeMUX ( {h}^{MUX} , {k}^{i} ) \qquad ( 2 - 6 )$$

$${h}_{j}^{i} = DeMUX ( {h}_{j}^{MUX} , {k}^{i} )$$

Akin to RSA, vᵢ and kᵢ can be treated as the keys for multiplexing (encryption) and demultiplexing (decryption), while ensuring that unlike DataMUX the input sequence length does not change and thereby leading to an improvement in throughput. Importantly, this architecture ensures that the keys better transfer across the different stages of training as they are no longer conditioned on the input instances.

The pre-training hyperparameters used in this example are described in Table I, below.

All pre-training related hyper-parameters are reported in Table I. Generally, the HuggingFace Transformers implementations were used for BERT and ELECTRA models. All pre-training experiments were run on 8 A100 GPUs with distributed training. A small hyper-parameter search over two learning rates. All pre-trained models are primed with the token retrieval task described herein. The models were trained on the Wikipedia and Bookscorpus datasets for up to 10000 training steps with a learning rate of 1e-4, and with a sequence length of.

For MUX-ELECTRA models, a generator as in the original ELECTRA work was not trained, but rather only a uniform-random token replacement was used. This is similar to what was used in ablations in ELECTRA. The generator randomly replaces 15% of tokens in the input with other tokens in the vocabulary.

TABLE I
Pre-train hyper-parameters for MUX-BERT and MUX-
ELECTRA models; results are only reported for the
Base configuration for MUX-ELECTRA models.

| | BERT | | | ELECTRA |
|---|---|---|---|---|
| Hyperparameter | Small | Base | Large | Base |
| Number of Layers | 4 | 12 | 24 | 12 |
| Hidden Size | 512 | 768 | 1024 | 768 |
| FFN intermed. | 2048 | 3072 | 4096 | 3072 |
| hidden size | | | | |
| Attention heads | 8 | 12 | 16 | 12 |
| Attention head size | 64 | 64 | 64 | 64 |
| Mask percent | 15 | 15 | 15 | N/A |
| Learning Rate Decay | Linear | Linear | Linear | Linear |
| Warmup steps | 10000 | 10000 | 10000 | 10000 |
| Learning Rate | [1e−4, | [1e−4, | [1e−4, | [1e−4, |
| | 5e−5] | 5e−5] | 5e−5] | 5e−5] |
| Adam ϵ | 1e−6 | 1e−6 | 1e−6 | 1e−6 |
| Adam β₁ | 0.9 | 0.9 | 0.9 | 0.9 |
| Adam β₂ | 0.999 | 0.999 | 0.999 | 0.999 |
| Attention Dropout | 0.1 | 0.1 | 0.1 | 0.1 |
| Dropout | 0.1 | 0.1 | 0.1 | 0.1 |
| Batch Size | 256 | 256 | 256 | 256 |
| Sequence Length | 512 | 512 | 512 | 512 |
| Train Steps | 1M | 1M | 1M | 1M |

All the fine-tuning related hyper-parameters are reported in Table II, below. A small hyper-parameter search was run on the learning rate, batch size and number of training steps for different tasks. All models were trained with half-precision. Numbers are reported on the validation split. For GLUE tasks, the default metrics in Wang et al. (2018) were used, and F1 was used for the token-level tasks. All fine-tuning experiments were trained on 1 V100 GPU.

TABLE II
Fine-tune hyperparameters.

| Hyperparameter | Value |
|---|---|
| Learning Rate | [2e−5, 5e−5] |
| Adam ϵ | 1e−8 |
| Adam β₁ | 0.9 |
| Adam β₂ | 0.999 |
| Learning Rate Decay | Linear |
| Warmup fraction | 0.1 |
| Attention Dropout | 0.1 |
| Dropout | 0.1 |
| Weight Decay | 0 |
| Batch Size | [32, 128] for Small/Base, [16, 64] for Large |
| Train Steps | 2000 for RTE and WNLI |
| | 10000 for MRPC, COLA, and STSB |
| | 20000 for NER, SST2, QNLI and POS |
| | [20000, 100000] for MNLI and QQP |
| Sequence Length | 128 |

In this example, all nine datasets from the GLUE benchmark were used, which are CoLA, SST-2, MRPC, (qqp), STS-B, MNLI, QNLI, RTE, and WNLI. The exemplary approach was also evaluated on token classification tasks such as named entity recognition (NER) and POS tagging. Here, the average over WNLI and CoLA are not reported, as these are the two smallest tasks in GLUE and high variance was observed across different seeds. Scores for all tasks in the appendix.

Variance across seeds All models were evaluated across 5 different seeds as variance was seen for smaller datasets. This variance is caused by the order in which instances were multiplexed in the dataset. Therefore, what is reported is both the average and maximum scores across different seeds in Table III, below, to understand the importance of cleverly sampling the multiplexed instances. The average across the seeds are reported for all other results.

Specifically, this example experiments with two different models pre-trained as described herein—ELECTRA (Clark et al., 2020) and BERT (Devlin et al., 2019) and present pre-trained multiplexed models for both these models for N=2, 5 and 10. They are compare against DataMUX multiplexed models and against baseline ELECTRA and BERT models across three different model configurations (small, base, and large). A random generator was used to train the MUX-ELECTRA models, presented as an ablation in Clark et al. (2020), instead of using a smaller masked LM due to compute limitations.

TABLE III
Average GLUE and Average token-level classification scores
for the base (L = 12, H = 768) configuration,
across both ELECTRA and BERT models for N = 1, 2, 5, 10.

| | | GLUE | | Token | | |
|---|---|---|---|---|---|---|
| Model | N | EL | BERT | EL | BERT | Throughput |
| Standard | 1 | 82.1/82.1 | 85.4/85.4 | 95.3/95.3 | 95.8/95.8 | 1.0 |
| DataMUX | 2 | 60.4/61.8 | 60.4/61.8 | 81.4/81.5 | 81.4/81.5 | 1.9 |
| PT-DataMUX | | 82.5/83.1 | 82.5/83.4 | 95.0/95.1 | 95.2/95.4 | 2.0 |
| DataMUX | 5 | 59.7/60.6 | 59.7/60.6 | 81.3/81.5 | 81.3/81.5 | 4.4 |
| PT-DataMUX | | 79.8/80.5 | 80.3/80.9 | 93.4/93.5 | 93.6/93.6 | 4.9 |
| DataMUX | 10 | 58.1/59.1 | 58.1/59.1 | 79.7/80.0 | 79.7/80.0 | 8.4 |
| PT-DataMUX | | 78.2/79.0 | 77.8/78.8 | 91.7/91.8 | 91.6/91.8 | 9.8 |

It is observed in Table III, that the method PT-DataMUX outperforms DataMUX for both ELECTRA and BERT on all values of multiplexing N, with improvements between 12 and 20 points on GLUE and token-classification tasks respectively. This shows the benefit of pre-training for data multiplexing, as opposed to using randomly initialized Transformers which are fine-tuned. It is noticed that the improvement of PT-DataMUX over DataMUX is consistent across all values of N. Furthermore, PT-DataMUX's efficient RSA inspired demultiplexing method allows it to achieve faster throughput than DataMUX, increasing it by over 16% for N=10.

DataMUX provides a significant boost in throughput (N times faster) when compared to standard performance of the base or backbone neural network, without a significant performance loss. For example, for ELECTRA (N=2), PT-DataMUX is within 0.4 points better and only 0.3 points worse than standard for GLUE and TOKEN, while being 2× faster. Similarly, for BERT (N=2), PT-DataMUX is within 3 and 0.6 points of Standard for GLUE and TOKEN, while being significantly faster. It is also observed that as N increases, PT-DataMUX's throughput is significantly better, but naturally the gap to standard is larger. This is because a large N implies that PT-DataMUX has to parallel process more instances, thus having to share its parameters and activations with a larger number of instances, which improves throughput and reduces performance. For example, the gap between Standard and PT-DataMUX ELECTRA on TOKEN for N=2 is 0.2 points and increases to 3.5 points for N=10, which shows that N serves as a parameter to control the performance-throughput tradeoff. N in PT-DataMUX allows the user to find the fastest model for a certain performance threshold. The results show that PT-DataMUX works both with BERT and ELECTRA, and we see similar trends and performance for different values of N.

In can be shows that the disclosed multiplexing techniques work on a host of model sizes and results are reported for PT-DataMUX BERT on three model sizes (small, base, and large) for N=2 (see Table IV, below).

TABLE IV

| | | GLUE | Token | |
|---|---|---|---|---|
| Configuration | Model | (Acc %) | (F1%) | Throughput |
| Small | Standard | 80.6 | 94.0 | 5.9x |
| | DataMUX | 59.5 | 81.8 | 8.7x |
| | PT-DataMUX | 79.0 | 93.3 | 11.5x |
| Base | Standard | 85.4 | 95.8 | 1.0x |
| | DataMUX | 60.4 | 81.4 | 1.9x |
| | PT-DataMUX | 82.5 | 95.2 | 2.0x |
| Large | Standard | 85.8 | 95.6 | 0.3x |
| | DataMUX | 61.7 | 80.9 | 0.6x |
| | PT-DataMUX | 84.1 | 95.2 | 0.6x |

Similar results were seen at larger N. PT-DataMUX's performance is close to that of standard for all model sizes while having a significantly better throughput (In Table IV, ≈2×). For example, the gap is less than 0.7 points for TOKEN tasks and 2.9 points for GLUE. Multiplexing works effectively on all the model sizes, with the drops with respect to Standard being 1.6 and 1.7 points on GLUE for Small and Large respectively. In Table IV, PT-DataMUX's throughput is always ≈2× that of Standard, which shows that a spectrum of PT-DataMUX model sizes can be multiplexed during pre-training without losing much performance and with significantly higher throughput.

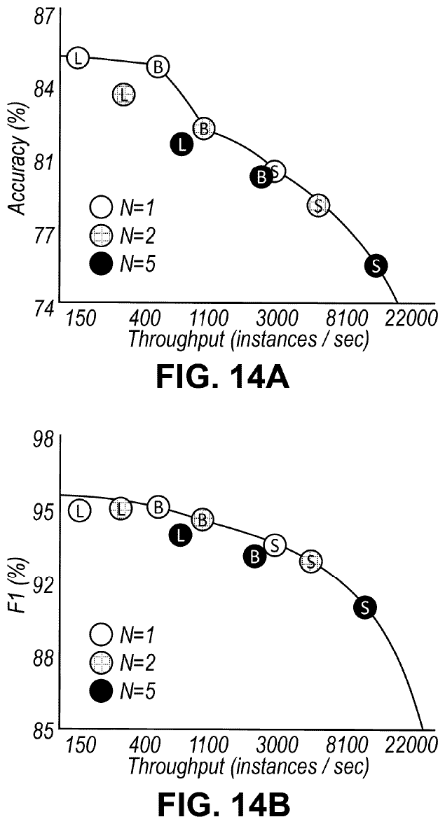

Pre-trained models typically have a performance-computational efficiency trade-off, with larger models having better performance but worse computational efficiency. PT-DataMUX offers a similar trade-off, with large N leading to better throughput but lower performance. To understand this trade-off, the performance and throughput of Standard (N=1) and PT-DataMUX (N=2 and N=5) were plotted for different model sizes (L=Large, B=Base, S=Small) and the pareto-optimality envelope was marked (solid black line). See FIGS. 14A and 14B. For any model on the envelope, no model has both better accuracy and throughput. If a user were choosing a model, they would only choose one on the envelope because, for every model within the envelope, there always exists a model on the envelope which has both better performance and throughput. It is observed that all multiplexed models lie either on or very close to the Pareto frontier, for both TOKEN and GLUE tasks. This allows users to choose a multiplexed model based on accuracy and throughput specifications, whereas with Standard models they would have lesser freedom with regards to how fast the model is. For example, say a user wanted a GLUE model with an accuracy better than 77% and that is as fast as possible. The Standard model they would choose would be the small configuration with a throughput of 2815 (in/s), but the PT-DataMUX model would be the N=2 small configuration with a significantly larger throughput of 9 (in/s). This suggests that given an accuracy threshold, multiplexed models will usually be faster than their non-multiplexed counterparts.

Ensembling PT-DataMUX. When multiplexing pre-trained models, N different instances can be fed to PT-DataMUX instead of a single instance, which leads to significantly improved throughput. Here, an alternate setting is considered where the same instance is fed N times and an ensemble is built by averaging the N class logits and making a single prediction. The Base models for N=2, 5, 10 for both BERT and ELECTRA are used, and it is compared to PT-DataMUX which does not use ensembling. See Table V, below.

TABLE V

| | | MNLI | | | QQP | | |
|---|---|---|---|---|---|---|---|
| Model | Mux(N) | No Ens | Ens | Δ | No Ens | Ens | Δ |
| BERT | 2 | 80.6 | 81.2 | +0.6 | 90.4 | 90.8 | +0.4 |
| | 5 | 77.2 | 78.8 | +1.6 | 88.8 | 89.7 | +0.9 |
| | 10 | 73.6 | 74.8 | +1.2 | 86.9 | 87.7 | +0.8 |
| ELECTRA | 2 | 80.3 | 80.8 | +0.5 | 90.6 | 90.9 | +0.3 |
| | 5 | 77.0 | 78.4 | +1.4 | 89.1 | 89.9 | +0.8 |
| | 10 | 74.6 | 76.0 | +1.4 | 87.6 | 88.3 | +0.7 |

The ensemble model does significantly better than the non-ensemble variant on both MNLI and QQP for all the values of N considered (e.g., 1.6 and 0.9 points on N=5 BERT for the two tasks). Further, it is noted that the improvement over the non-ensemble variant (A) is better for higher N, potentially because the ensemble size is larger as a result of logits being averaged over more samples. This result shows that the non-ensemble variant is faster but performs slightly worse, while the ensemble variant performs better but is slower. A spectrum of models lie between these two extremes, where only a fraction of the N muxed representations can be ensembled, allowing users to pick where in the performance-speed trade-off they want their model to lie.

Ablation analysis. Multiplexing and demultiplexing components of PT-DataMUX were analyzed, and the results were reported in Table VI, below. Two variants are considered, one which uses prefix demultiplexing proposed for DataMUX instead of the proposed RSA-MUX and another which uses Contextual multiplexing instead of Non-contextual.

TABLE VI
Ablation analysis for MUX-BERT (based
configuration) for N = 2, 5, 10.

| Mux | | | | GLUE | Token |
|---|---|---|---|---|---|
| (N) | Model | Mux | Demux | (Acc %) | (F1%) |
| 2 | PT-DataMUX | Non-contextual | RSA-MUX | 82.5 | 95.2 |
| | Ablation 1 | Non-contextual | Prefix | 83.2 | 95.3 |
| | Ablation 2 | Contextual | RSA-MUX | 82.3 | 95.3 |
| 5 | PT-DataMUX | Non-contextual | RSA-MUX | 80.3 | 93.6 |
| | Ablation 1 | Non-contextual | Prefix | 78.6 | 38.9 |
| | Ablation 2 | Contextual | RSA-MUX | 76.8 | 94.2 |
| 10 | PT-DataMUX | Non-contextual | RSA-MUX | 77.8 | 91.6 |
| | Ablation 1 | Non-contextual | Prefix | 76.6 | 25.6 |
| | Ablation 2 | Contextual | RSA-MUX | 76.0 | 93.3 |

Variant 1 which uses prefix demultiplexing performs worse than PT-DataMUX, other than for N=1. In fact, Variant 1 does not converge for TOKEN tasks for N=2 and N=5 and performs 1.7 and 1.2 points worse on GLUE when compared to PT-DataMUX. This shows that the RSA-inspired demultiplexer performs better than that of the DataMUX variant.

Variant 2 uses contextual multiplexing which takes into account other tokens present in the instance and also tokens present in the same position of other instances. Across the board, it is noted that it performs better than PT-DataMUX for TOKEN tasks but performs worse for GLUE tasks. The improvement it has over PT-DataMUX on TOKEN for N=10 is over 1.7 points. We believe that contextual multiplexing's better performance in TOKEN is because the model needs to make a prediction for every single position in the instance, which requires it to efficiently multiplex all token positions in the output. On the contrary, for GLUE tasks, the model needs to make a prediction only for the [CLS] token, for which PT-DataMUX's multiplexing suffices.

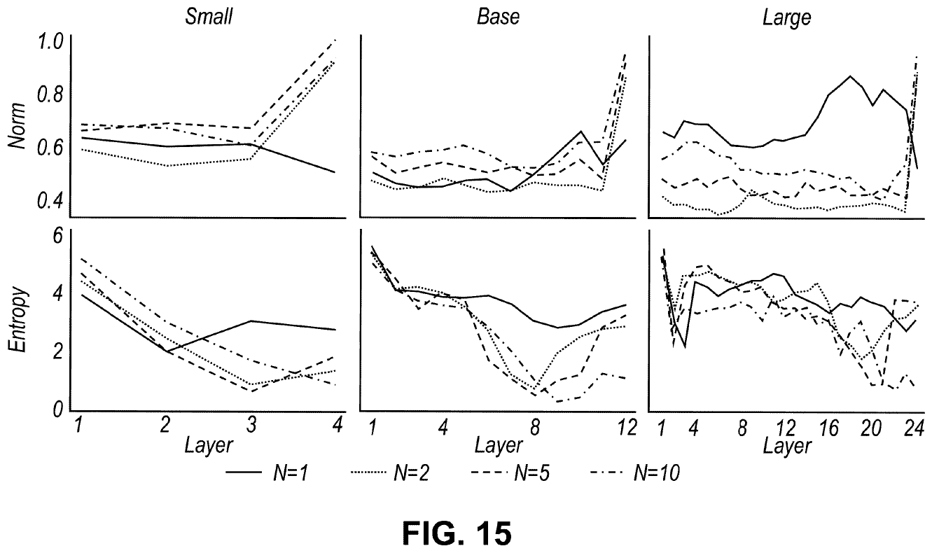

Muxology: Analyzing hidden representations of multiplexed models. To understand the nature of representations being learned by pre-trained MUX-BERT models, the activations and attention weights were analyzed. Specifically, the absolute value of activations and entropy of the attention distribution across all the layers of the Transformer encoder were noted, averaged over the evaluation split of WikiText-103. See FIG. 15. This analysis is reported for different values of N and for different model sizes.

Activation norms spike for multiplexed models in the last layer. FIG. 15 (top) shows that activation norms spike in the last layer for multiplexed models. It is believed that this is because the model is preparing for demultiplexing and is packing information from all N instances, which makes the activations denser. Because of the significantly higher norms in the last layer, when compared to intermediate layers, it is posited that PT-DataMUX has learned to efficiently encode multiple instances until the last layer where it needs to make independent predictions for them.

Entropy of the attention weights of multiplexed models is lower than that of non-multiplexed models for higher layers. FIG. 15 (bottom) suggests that multiplexed models tend to have lower entropy attention distributions on average as opposed to the baseline non-multiplexed model (N=1) for higher layers. This implies peakier attention distribution for multiplexed models when compared to their counterparts. It is believed this is related to an observation made by others of pre-trained models having peaky attention distributions in the higher layers, with small irregularities. Since the model implicitly has to use the same attention distribution for all the multiplexed instances, the peaky distribution gets reinforced. This is further corroborated by higher N having lower entropy in the final layer. Taken together, it is believed that PT-DataMUX has learned how to create shared representations for multiple instances so as to effectively use the instance-independent attention distribution.

### Data Sampling Strategies During Inference.

PT-DataMUX can parallel process multiple instances (N), and here it is utilized during inference by sampling N instances uniformly at random from the evaluation set. But other sophisticated data-sampling strategies can exist, for example, clustering similar instances and processing them together or considering instances which have lowest word-overlap. In this section, we explore the effect of composition of N instances on the performance of PT-DataMUX. For each model variant, this example considers 5 random seeds which can be viewed as lottery tickets. Since the random seed controls the composition of N instances, we measure the difference between the best performing ticket and the worst performing ticket and average the performance for all the GLUE tasks (see Table VII, below).

TABLE VII

| | ELECTRA | | | BERT | | |
|---|---|---|---|---|---|---|
| N | Best Ticket | Worst Ticket | Δ | Best Ticket | Worst Ticket | Δ |
| 2 | 83.1 | 82.0 | 1.1 | 83.4 | 81.8 | 1.6 |
| 5 | 80.5 | 78.9 | 1.6 | 80.9 | 79.7 | 1.2 |
| 10 | 79.0 | 77.3 | 1.7 | 78.8 | 77.0 | 1.8 |

It is noted that the difference (A) is consistently greater than 1 point for all values of N for both ELECTRA and BERT, which shows that there is a significant performance difference between the best and worst ticket. This shows the importance of the composition of N instances, and it is believed that the improved data sampling strategy both during inference and training can lead to better performance.

Finally, model compression for high throughput transformers can be used in conjunction with the above. For example, in some embodiments, the method may include compressing at least one transformer of a neural network model located between the multiplexing layer and a demultiplexing layer. The compression may occur via, e.g., the well-understood concepts of network pruning and/or distillation.

In some embodiments, the method may include predicting, using a task accuracy model and a throughput model, parameters that improve throughput and meet a given accuracy budget. The task accuracy model is generally configured to estimate accuracy for a range of multiplexer widths (N) and pruning sparsities (s). The throughput model is generally configured to estimate throughput for a range of multiplexer widths and pruning sparsities. Starting from a given accuracy budget, the two models can be used together do find a target (N, s) that is may be an optimal set of values.

### Example 3

Large language models (LLMs) have achieved state-of-the-art performance across various NLP tasks and resulted in impressive user-facing demonstrations such as ChatGPT. However, their large size necessitates the use of enormous amounts of compute and memory at inference time, which limits their widespread use. In addition to the multiplexing techniques disclosed herein, another type of technique that has been explored for reducing the cost of model inference is model compression including network pruning, quantization, and/or knowledge distillation.

While both types of methods leverage the over parameterization effect in modern deep neural networks to improve the throughput-to-compute cost ratio, the manner in which they do so is different. Model compression aims at reducing the number of parameters in the model, hence reducing the overall compute cost (denominator) to improve the ratio. Data multiplexing, on the other hand, compresses multiple inputs into one to improve throughput (numerator) while keeping the model size fixed.

Thus, it may be feasible to combine the two methods. However, there are two challenges to this hypothesis.

The first is that both model compression and data multiplexing aim at trading a small accuracy loss for large throughput improvement. Intuitively, the combination may incur an accuracy loss larger than either method and it is not clear how they interact with each other when combining them together. A research question is how to combine the two methods such that the combination achieves better throughput than each type of method individually, given any accuracy loss budget or accuracy threshold. The second challenge is to efficiently find the best parameters pair (N, s) where N is the width of the data multiplexing and s is the sparsity of the model compression method. Training and testing with each parameter combination is costly and time-consuming. A research question is how to automatically find the best parameters without additional training and testing.

To address the first research question, disclosed is PruMUX, a combination of model compression and data multiplexing. The method is simple and consists of three phases—multiplexed model pre-training, task-specific fine-tuning, and task-specific model compression. This implementation makes use of CoFi (Xia et al., 2022), a state-of-the-art model compression method which includes intermediate knowledge distillation steps that help minimize accuracy hits and DataMUX, which performs vector-based input multiplexing over instances. The results over four datasets (MNLI, QNLI, QQP and SST-2) demonstrate that PruMUX achieves significantly higher throughput over CoFi and DataMUX individually for a large range of accuracy thresholds.

To address the second research question, disclosed is Auto-PruMUX, a meta-model to automatically predict the high-performance parameter combinations for a desired accuracy on a task without running experiments. Linear and cubic interpolation models are used over a few sparse data points to predict the throughput and accuracy of a Pru-MUX model based on sparsity and multiplexing factor. This has shown promise in modeling the trade-offs accurately and Auto-PruMUX can find high-performance combinations of known parameters as well as unknown parameters, providing a practical method for choosing an high-performance Pru-MUX model for a downstream task.

PruMUX can achieve better throughput than model compression and data multiplexing individually is that they improve the throughput of a model in two different dimensions: reducing the latency of an inference and compressing multiple inferences. In addition, both methods lead to non-linear drops in model accuracy at some points. PruMUX can achieve high throughput while avoiding each method's limitations.

### CoFi Pruning

CoFi is a state-of-the-art model compression method (Xia et al., 2022) that uses distillation and structured pruning to jointly prune a Transformer network. Its key idea is to distill the knowledge from the base model into the pruned model during training. A layer-wise distillation approach is used to guide the pruning from the teacher model, i.e., dense model, to the student model, i.e., pruned model, with a loss defined as:

$${L}_{distill} = {\sum }_{i ∈ r} MSE ( {W}_{layer} {H}_{s}^{m ( i )} , {H}_{t}^{( i )} )$$

where Hₛ^{m(i)} and Hₜⁱ are hidden representations of the m(i)-th feed-forward layer of the student model and i-th feed-forward layer of the teacher model. i is the teacher model's closest layer to the layer m(i) of the student model.

CoFi prunes both coarse-grained and fine-grained units of the distilled network. The coarse-grained units include multi-head attention layers, fully-connected layers, and attention heads. The fine-grained units include hidden dimensions, and intermediate dimensions of the Transformer model. Different masks are used for different pruning units and are learned via l0 regularization during training. The units with mask variables smaller than a threshold are pruned away before inference.

A key motivational question is the following: given an accuracy loss budget, can the combination of model compression and data multiplexing achieve better throughput than each method individually?

PruMUX is a method to combine the two methods, and it is shown that PruMUX achieves substantially better throughput than each method alone for various accuracy thresholds in our experimental results.

PruMUX is a method to convert any Transformer into a high throughput model, capable of compressing multiple inference inputs into a single input and executing it at a low latency. For multiplexing, PruMUX uses DataMUX (including, e.g., PT-DataMUX), which appends a multiplexer and demultiplexer as described herein. With width N, the inference throughput of the Transformer can be improved by a factor of up to N, as each multiplexed input takes the same amount of computing resources as performing inference over a single input.

For model compression, PruMUX can use any method such as network pruning, distillation, or a combination of the two (such as CoFi). The goal is to substantially reduce the latency of processing an inference. For our experiments, PruMUX uses CoFi as the model compression method.

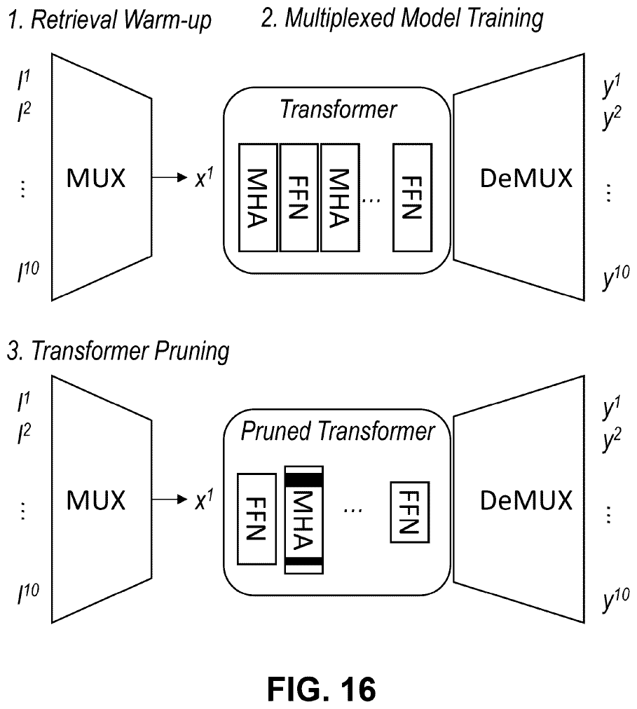

Training a model with PruMUX consists of three phases as shown in FIG. 16.

Phase 1: Priming the multiplexed model with the token retrieval objective. The multiplexed transformer model is first primed with a token retrieval task as disclosed herein. Introducing this “retrieval warm-up” self-supervised objective (shown below) appears to be high significant for improving the performance of multiplexed models.

$${L}_{retrieval} ( {x}^{1 : N} ) = {\sum }_{j = 1}^{L} - log P ( {w}_{j}^{I} \vert {H}_{j}^{I} )$$

Phase 2: Pre-training and fine-tuning multiplexed models. The multiplexed models from the previous phase are then pre-trained on large-scale text corpora with the masked language modeling (MLM) objective. The pre-trained multiplexed models are then fine-tuned on downstream tasks to yield task-specific multiplexed models.

Phase 3: Model compression. Finally, a model compression technique (here, CoFi) is used to jointly prune coarse-grained and fine-grained units in the multiplexed Transformer model. The coarse-grained units include entire attention heads, attention layers, and fully connected layers. The fine-grained units include hidden dimensions and intermediate dimensions of the Transformer model. The demultiplexer's input dimension is pruned in order to match the pruned hidden dimension of the Transformer model. During the pruning process, CoFi uses knowledge distillation to transfer knowledge from the teacher model, i.e., the task-specific multiplexed model, to the pruned model.

As understood in the art, model compression reduces the number of model parameters with minimal loss in task performance. A well-studied method is network pruning, which removes unimportant connections or weights from a network with minimal or no accuracy loss. Unstructured pruning does not impose any constraints on the locations of non-zero weights. The resulting network can achieve high sparsity but may not run efficiently on common hardware such as GPUs. Structured pruning produces structured sparse matrices that can take better advantage of the parallelism in existing hardware, but its sparsity is relatively lower than the unstructured pruning method for the same accuracy loss budget. Structured pruning has been applied to transformers to improve inference throughput.

Distillation compresses a model by transferring knowledge from a large teacher model to a small student model. General distillation for Transformer models learns from unlabeled corpus. Task specific distillation for Transformer models learns on task-specific data combines the two distillation methods to improve performance. Xia et al., 2022 proposes structured pruning with distillation objective to reduce the Transformer parameters by up to 95% and achieve over 10× speedups with small accuracy drops.

Implementation Details. The multiplexed BERT-base models are pretrained with the standard BERT pre-training recipe with the masked language modeling objective for N=2, 5, 10 on Wikipedia and BooksCorpus datasets. The multiplexed model is primed before pre-training with the token-retrieval task on the Wikipedia and Bookscorpus datasets. The pre-trained multiplexed models are then trained on the four largest GLUE Tasks—MNLI, QNLI, QQP, and SST-2. The CoFi structured pruning objective is then used to get a pruned multiplexed model on each task dataset. The hyperparameters used for the training process are shown in Table VIII, below. A single run was performed to train the model for each setting, i.e., task, multiplexer width N, model sparsity s, following the training process.

TABLE VIII
Hyperparamaters in CoFi training and PruMUX training.

| Hyperparameter | CoFi | ProMUX |
|---|---|---|
| Distill layer loss alpha | 0.9 | 0.9 |
| Distill ce loss alpha | 0.1 | 0.1 |
| Layer distill version | 4 | 4 |
| Sparsity epsilon | 0.01 | 0.01 |
| Max seq length | 128 | 128 |
| Pruning batch size | 32 | 32*N |
| Finetune batch size | 64 | 64 |
| Training epoch | 20 | 20 |
| Finetune epoch | 20 | 20 |
| Distill temp | 2 | 2 |
| Scheduler type | Linear | Linear |
| Prepruning finetune epoch | 1 | 1 |
| Lagrangian warmup epoch | 2 | 2 |
| Pruning learning rate | 2e−5 | 5e−5 |
| Finetune learning rate | 3e−5 | 3e−5 |
| Retrieval loss coeff | — | 0.1 |

To answer the question of whether the PruMUX method can achieve a higher throughput than either CoFi or DataMUX alone, given an accuracy threshold, a PruMUXed BERT-base model was compared to three baselines:
BERT-base: BERT-base model trained without data multiplexing and model compression.
CoFi: BERT-base model pruned by CoFi with sparsity s=0.50, 0.60, 0.70, 0.80, 0.90, and 0.95 (here, sparsity of 0.95 means 95% of the Transformer model weights are set to zero).
DataMUX: BERT-base model pre-trained by DataMUX with the multiplexer width N=2, 5, and 10.
PruMUX was applied to the BERT-base model with all combinations of (N,s) for all 4 tasks. The procedure in Xia et al. (2022) was followed to calculate throughput improvements for PruMUXed Transformers and all three baselines, i.e. BERT-base, DataMUX, and CoFi.

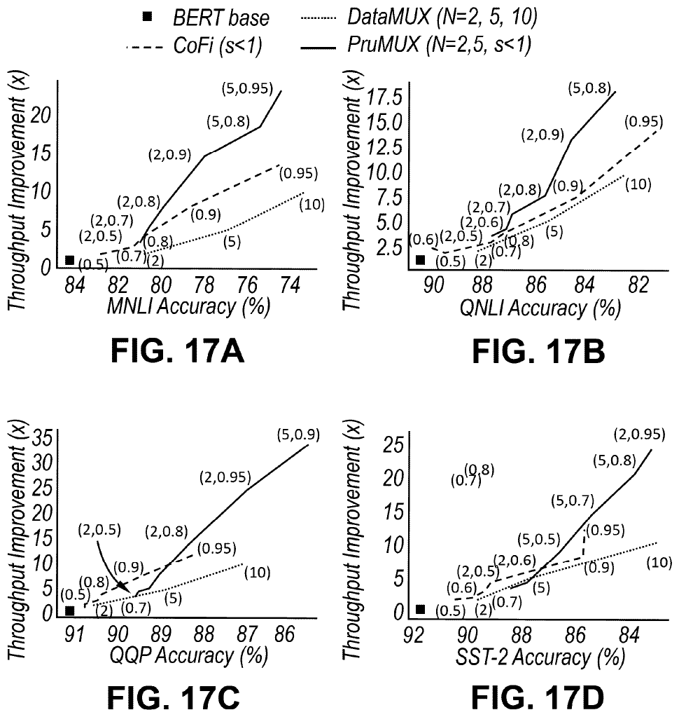

FIG. 17 shows the throughput improvements and accuracies of PruMUXed, DataMUXed, and CoFi-Pruned Transformers over the Transformer base model on the MNLI, QNLI, QQP, and SST-2 tasks with all available parameters.

As is seen, PruMUX achieves higher throughput than either CoFi or DataMUX individually in all cases starting at various accuracy thresholds:

For MNLI, with the accuracy thresholds from 80% to 74%, PruMUX achieves 5.5-23.0× throughput improvement over the BERT-base model, whereas CoFi improves by 4.0-13.3× and DataMUX by 2.0-4.9×.

For QNLI, with the accuracy thresholds from 87% to 82%, PruMUX achieves 4.3-18.6× improvement, whereas CoFi improves by 3.9-7.5× and DataMUX by 2.0-9.8×.

For QQP, with the accuracy thresholds from 89% to 86%, PruMUX achieves throughput improvement over BERT-base by 5.5-24.2×, whereas CoFi improves by 7.6-11.7× and DataMUX by 2.0-9.8×.

For SST-2, with the accuracy thresholds from 86.5% to 83%, PruMUX improves the throughput by 8.7-23.4×, whereas CoFi improves by 4.4-12.3× and DataMUX by 4.9-10.1×.

The results also confirm the intuition that PruMUX with (N, s) incurs an accuracy loss, loosely speaking, close to the sum of the accuracy loss of DataMUX with N and that of CoFi with s. In general, PruMUX can achieve substantial throughput improvement when there is a decent accuracy loss budget.

The results above require training and testing PruMUX with all 18 parameter pairs (N,s) where N=2, 5, 10 and s=0.50, 0.60, 0.70, 0.80, 0.90, and 0.95. With all the testing results, for any accuracy threshold, one should quickly find the best parameters.

Exhaustive tests are impractical. First, for each N, pre-training a DataMUX model with multiplexing width N is time-consuming. Second, given each pre-trained model with multiplexer width N, different sparsities s provide different throughput and accuracy trade-offs. In order to find the sparsity s with the highest throughput given an accuracy budget, one has to train the model for all possible sparsities. The total training time for the sparsities at the granularity of 0.05 for each N takes over a thousand GPU hours on commodity GPUs, for a small original BERT-base model.

A key question is whether one can automatically find a high-throughput (N, s) with minimal number of PruMUX experiments.

### Auto-PruMUX.

To address that question above, Auto-PruMUX is proposed, a method to search for best (N, s) parameters, to help practitioners balance the performance vs throughput trade-off. The research question is: Suppose one has some experimental data of DataMUX with a set of parameter N's and some of CoFi with a set of s's, how can the high-performance parameter (N, s) be found without training PruMUX models?

The approach used was to develop performance models for the accuracy and throughput of PruMUX. To do this, it was required to first train PruMUX models for a large set of (N, s) combinations and measure both the accuracy and the throughput improvement. One can then use this data to fit a throughput model and an accuracy model to predict throughput and accuracy respectively given (N, s) parameters.

It is first discussed how to fit the accuracy and throughput models with a few sparse data points. Given that these examples are working with a limited set of data points, it is opted to use a simple class of interpolation models for modeling PruMUX accuracy and throughput. It is then outlined how to leverage these models to predict (N, s) parameters, given an accuracy budget. The PruMUX models are then trained with the predicted configurations to demonstrate Auto-PruMUX's ability to predict better parameters without additional training.

Task Accuracy Model. Linear interpolation is used for our task accuracy model.

$${f}_{A} ( N , s ) = \{ \begin{matrix}{A}_{1 , 1} ( N , s ) {N}_{0} \leq N \leq {N}_{1} , {s}_{0} \leq s \leq {s}_{1} \\ … \\ {A}_{1 , j} ( N , s ) {N}_{i - 1} \leq N \leq N , {s}_{j - 1} \leq s \leq {s}_{j} \\ … \\ {A}_{p , q} ( N , s ) {N}_{p - 1} \leq N \leq {N}_{p} , {s}_{q - 1} \leq s \leq {s}_{q}\end{matrix}$$

Each term is a linear combination of data multiplexer width and model sparsity.

$${A}_{i , j} ( N , s ) = {\sum }_{a = 0}^{1} {\sum }_{b = 0}^{1} {k}_{ab}^{( i , j )} {N}^{a} {s}^{b}$$

The model is fitted on the gathered data of model task accuracy at different multiplexer width and sparsity.

$${A}_{i , j} ( {N}_{i} , {s}_{j} ) = Acc ( {N}_{i} , {s}_{j} ) i = 1 , … , p , j = 1 , … , q$$

where N and s are the range of N and s values used to fit the model.

### Throughput Model

Cubic interpolation is used on throughput data (other approaches (e.g., linear regression, etc.) may be used, although results may not be as improved as with cubic interpolation).

$${f}_{T} ( N , s ) = \{ \begin{matrix}{T}_{1 , 1} ( N , s ) {N}_{0} \leq N \leq {N}_{1} , {s}_{0} \leq s \leq {s}_{1} \\ … \\ {T}_{i , j} ( N , s ) {N}_{i - 1} \leq N \leq N , {s}_{j - 1} \leq s \leq {s}_{j} \\ … \\ {T}_{p , q} ( N , s ) {N}_{p - 1} \leq N \leq {N}_{p} , {s}_{q - 1} \leq s \leq {s}_{q}\end{matrix}$$

Each term is defined as a cubic combination of N and s.

$${T}_{i , j} ( N , s ) = {\sum }_{a = 0}^{3} {\sum }_{b = 0}^{3} {k}_{ab}^{( i , j )} {N}^{a} {s}^{b}$$

The throughput model is fit on collected data points and their throughput.

$${T}_{i , j} ( {N}_{i} , {s}_{j} ) = Throu ( {N}_{i} , {s}_{j} ) i = 1 , … , p , j = 1 , … , q$$

where N and s are the range of N and s values used to fit the model.

### Predicting (N, s)

The models (f_{A}(N,s) and f_{T}(N,s)) are used to search for (N,s) parameters that maximize ζ_{f} defined below

$${ζ}_{f} ( N , s ) = {f}_{T} ( N , s ) \cdot g ( {f}_{A} ( N , s ) )$$

$$g ( x ) = \{ \begin{matrix}1 & x \geq ξ \\ 0 & x < ξ\end{matrix}$$

Intuitively, ζ_{f} tries to tradeoff task performance and throughput, given a performance budget ζ with the goal of maximizing the throughput. g(x) provides a mechanism for a strict accuracy threshold—i.e. a model that does not meet the minimum required accuracy will have ζ_{f}=0.

The goal is to evaluate the task accuracy model, the throughput model, and parameter prediction performance. To evaluate the performance models on the accuracy and throughput data, performance data was collected for different (N, s) parameters on each task. Leave-one-out cross validation was used to fit the performance models using part of the data and evaluate how well they perform on the rest of the data not used in model fitting. The fraction M_{A} of valid accuracy predictions, i.e., with error falling within Δξ=2% from real accuracy, and the fraction M_{T} of valid throughput predictions, i.e., with error within 30% of real throughput, are shown in Table IX, below.

TABLE IX

| Task | M_{A} | M_{T} | Task | M_{A} | M_{T} |
|---|---|---|---|---|---|
| MNLI | 1 | 1.0 | QQP | 1.0 | 0.90 |
| QNLI | 0.8 | 0.90 | SST-w | 1.0 | 1.0 |

It is noted that across different tasks, the accuracy model and throughput model are accurate across a broad set of parameter combinations.

Predicting parameters without additional training. The utility of searching parameters with the throughput and accuracy models is demonstrated by fitting the models on the following subset of parameters—(N, s)∀N∈1, 2, 5, 10 ∀s∈0.00, 0.60, 0.95, and then using the fitted models to predict from a larger set of parameters—(N,s)∀N∈1, 2, 5, 10, ∀s∈0.00, 0.50, 0.60, 0.70, 0.80, 0.90, 0.95. The search is conditioned given an accuracy budget as defined previously. It is noted that making predictions with a finer granularity of N, i.e., N=2, 3, . . . , 10 with ΔN=1, could potentially improve the predicted throughput further, that was not done in this example.

Here, Auto-PruMUX was leveraged to make parameter predictions on the larger set of parameters defined earlier. Table X, below, shows parameter predictions made by Auto-PruMUX for different accuracy budgets on the MNLI task. Auto-PruMUX can generalize to parameter combinations it was not fit on and for different accuracy thresholds, predicts faster parameter configurations that are not part of the training data used to fit the Auto-PruMUX models.

TABLE X
Parameter Predictions and predicted throughput improvements.

| | Auto-PruMUX | | Auto-PruMUX | | Auto-PruMUX |
|---|---|---|---|---|---|
| | (Train) | | (Predicted) | | (Actual) |
| Acc. | (N, s) | | (N, s) | | [Acc., Throu.] |
| ≥78% | (2, 0.60) | 4.3x | (2, 0.7) | 8.5x | [80.4, 5.5] |
| ≥77% | (2, 0.60) | 4.3x | (2, 0.80) | 13.8x | [79.8, 7.9] |
| ≥75% | (5, 0.60) | 10.2x | (2, 0.90) | 19.9x | [77.9, 14.4] |

For instance, Auto-PruMUX suggests that the (2, 0.80) configuration for MNLI would lead to a higher throughput increase for an accuracy budget of 77% (see row 2). This prediction was verified by training the PruMUX model with that configuration and getting an accuracy of 79.8 and a throughput improvement of 7.9×. This shows Auto-PruMUX is able to generate better configurations without additional training.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for improving the throughput of a neural network, comprising:
receiving a plurality of inputs;
generating transformed inputs by performing, via a multiplexing layer, a transformation to each input of the plurality of inputs; and
combining the transformed inputs into a single compact representation of the plurality of inputs.

2. The method according to claim 1, wherein the transformation is a fixed linear transformation.

3. The method according to claim 1, further comprising transmitting the single compact representation of the plurality of inputs to a neural network.

4. The method according to claim 3, further comprising:
receiving an output from a neural network;
generating a plurality of values by converting, via a demultiplexing layer, the output back into independent representations; and
producing predictions for each input based on the plurality of values.

5. The method according to claim 4, wherein the demultiplexing layer utilizes a multihead neural network.

6. The method according to claim 5, wherein the multihead neural network is a multilayer perceptron.

7. The method according to claim 4, wherein the demultiplexing layer uses a set of input-specific keys or indices.

8. The method according to claim 7, wherein using a set of input-specific keys or indices comprises index embedding.

9. The method according to claim 4, further comprising a training phase, the training phase including a warmup step comprising retrieving correct tokens and order for each position and sequence of the plurality of inputs.

10. The method according to claim 9, wherein the training phase further comprises pretraining the neural network after the warmup step.

11. The method according to claim 10, wherein pretraining includes using a masked language modeling objective.

12. The method according to claim 10, wherein the training phase further comprises finetuning the neural network after pretraining.

13. The method according to claim 12, wherein finetuning includes training on a specific downstream task.

14. The method according to claim 1, further comprising compressing at least one transformer between the multiplexing layer and a demultiplexing layer via pruning and/or distillation.

15. The method according to claim 14, further comprising predicting, using a task accuracy model and a throughput model, parameters that improve throughput and meet a given accuracy budget.

16. A non-transitory computer-readable storage medium containing instructions that, when executed, cause a processor to perform operations that include:
receiving a plurality of inputs;
generating transformed inputs by performing, via a multiplexing layer, a transformation to each input of the plurality of inputs; and
combining the transformed inputs into a single compact representation of the plurality of inputs.

17-30. (canceled)

31. A system, comprising:
a processor; and
a non-transitory computer-readable medium operably coupled to the processor, the non-transitory computer-readable medium containing instructions that, when executed by the processor, causes the processor to perform operations that include:
receiving a plurality of inputs;
generating transformed inputs by performing, via a multiplexing layer, a transformation to each input of the plurality of inputs; and
combining the transformed inputs into a single compact representation of the plurality of inputs.

32-45. (canceled)

46. A neural network apparatus, comprising:
a processor operably coupled to memory, the processor configured to generate a neural network with a plurality of layers including:
a multiplexing layer configured to perform a transformation to each received input before combining them into a single compact representation;
one or more layers defining a base neural network, the base neural network configured to receive output from the multiplexing layer; and
a demultiplexing layer configured to convert output of the base neural network back into independent representations.

47-53. (canceled)
